(19) United States
(12) Patent Application Publication
(10) Pub. No.: US 2009/0146585 A1
(43) Pub. Date: Jun. 11, 2009

(54) Constant Power Driving-and-Controlling Method for Lighting Elements

(76) Inventors: Bin-Juine HUANG, Taipei (TW); Min-Sheng Wu, Taipei (TW); Ching-Dian Wong, Taipei (TW); Po-Chien Hsu, Taipei (TW)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/335,514

(22) Filed: Dec. 15, 2008

(30) Foreign Application Priority Data
Dec. 6, 2007 (TW) 096146430

(51) Int. Cl. H05B 37/02

(52) U.S. Cl. 315/294

(57) ABSTRACT

The present invention provides a constant power driving-and-controlling method for lighting elements so as to stably drive solid lighting elements. Measuring the input power of lighting elements by a power measuring device and then controlling the input power of the lighting elements by a feedback controller to stabilize the input power of the lighting elements, the effects of environment temperature and the difference of the electrical characteristics of the lighting elements on the input power can be eliminated.

The entire disclosure of Taiwan, R.O.C. Patent Application No. 096146430, filed Jun. 12, 2007, is incorporated herein by reference.

### BACKGROUND OF THE INVENTION

1. Field of the Invention

The present invention generally relates to a constant power driving-and-controlling method for lighting elements, and more particularly to a constant power feedback control method for stably driving lighting elements so as to vanish the disturbance of the application that may occur. In conditions such as the changing environment temperature, the unstable power source, or the differences of the electrical characteristics of the lighting elements by different production lots, the effects on the input power of the lighting elements may cause disturbance, for example, the illumination of the lighting elements may become too high or too low, or the lighting elements may be damaged.

2. Description of the Prior Art

Because of the many advantages of LEDs such as small volume, low input power, long lifetime, low cost and so on, the conventional lighting devices are replaced by LEDs gradually; moreover, a lot of new applications of LEDs are also produced.

Each LED is composed of an N type semiconductor and a P type semiconductor. The resistance of P-N junction (node) between the N type semiconductor and the P type semiconductor is very sensitive to the environment temperature. Therefore, the environment temperature influences the output illumination of the LED. When the environment temperature changes, the input power of the LED may become too high, causing excessive output illumination of the LED and thus overheating the LED Alternatively, the input power of the LED may become too low, causing the insufficient output illumination of the LED. For example, when the environment temperature increases, the resistance of P-N junction decreases, it is easy to cause the LED to have a high operating power and thus result in the overheated LED and the LED becomes overheated, then the lifetime of the LED is shortened. When the environment temperature decreases, the resistance of P-N junction increases, giving the LED a low operating power, resulting in insufficient output illumination of the LED to reach the required illumination. Furthermore, for different types of LEDs or the LEDs produced in different times, the resistances vary because of the material and process differences. Even when the LEDs are driven by a constant current, the output illumination of the LEDs could also vary due to different production lots. The excessive or insufficient illumination of the LEDs causes disturbances in the application.

Accordingly, a need has arisen to propose a novel constant power driving-and-controlling method for LEDs, so as to reduce the effects of the environment temperature on the input power of the LEDs, protect and extend the lifetime of the LEDs, and moreover, to stabilize the output illumination regardless of the effects of the environment temperature and the difference of the electrical characteristics of the LEDs.

### SUMMARY OF THE INVENTION

The present invention has been made in order to provide a constant power driving-and-controlling method for lighting elements so as to reduce the effects of the environment temperature on the input power of the lighting elements, and reduce the effects of the unstable input voltage or current on the input power of the lighting elements. In addition to protecting the lighting elements and extend the lifetime of the lighting elements, the present invention also stabilizes the output illumination of the lighting elements.

In order to achieve the above object, the present invention provides a constant power driving-and-controlling method for lighting elements so as to stably drive solid state lighting elements. Measuring the input power of lighting elements by a power measuring device then controlling the input power of the lighting elements by a feedback controller, the goal to stabilize the input power of the lighting elements and to eliminate the effects of the environment temperature and the difference of the electrical characteristics of the lighting elements on the input power is achieved.

### BRIEF DESCRIPTION OF THE DRAWINGS

FIG. 1A shows an electrical connect flow diagram of a constant power driving-and-controlling method for lighting elements in accordance with one preferred embodiment of the present invention;

FIG. 1B shows an electrical connect flow diagram of a constant power driving-and-controlling method for lighting elements in accordance with another preferred embodiment of the present invention;

FIG. 2A shows an electrical connect flow diagram of a constant power driving-and-controlling method for lighting elements in accordance with another preferred embodiment of the present invention;

FIG. 2B shows an electrical connect flow diagram of a constant power driving-and-controlling method for lighting elements in accordance with another preferred embodiment of the present invention;

FIG. 3A shows a part of the constant power driving-and-controlling method for lighting elements shown in FIG. 2A, specially, a PWM switch is used as a switch device;

FIG. 3B shows the relation between the DC voltage shown in FIG. 3A and the duty cycle controlling signal.

### DETAILED DESCRIPTION OF THE INVENTION

The detailed description of the present invention will be discussed in the following embodiments, which are not intended to limit the scope of the present invention, but can be adapted for other applications.

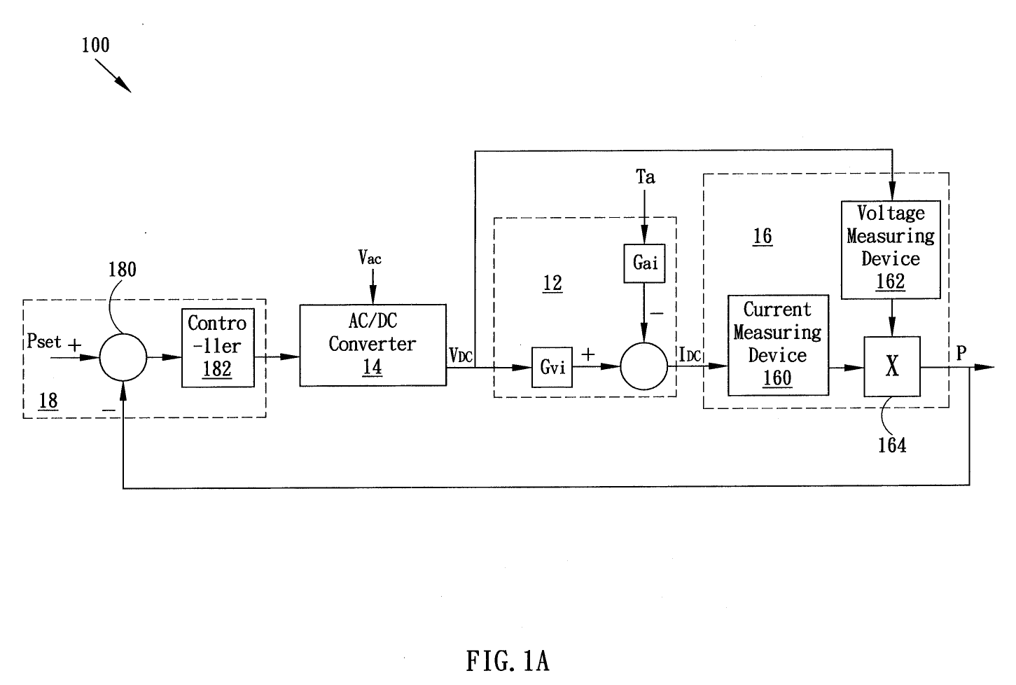

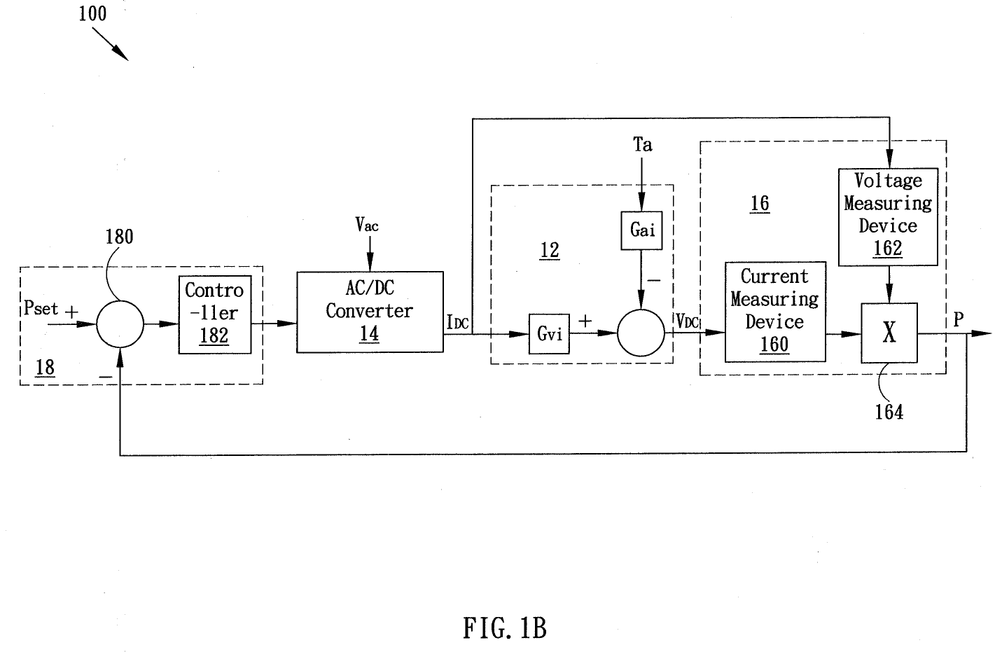

FIG. 1A shows an electrical connect flow diagram of a constant power driving-and-controlling method 100 for lighting elements in accordance with one preferred embodiment of the present invention. In this embodiment, the lighting elements are LEDs (Light Emitting Diode) 12. The output illumination of the LEDs is affected by the DC input voltage V_{DC} and the environment temperature Tₐ. Referring to the electrical connect flow diagram of LED 12, wherein the gain Gᵥᵢ is the function that the current passing through the LEDs affected by the DC input voltage, the gain Gₐᵢ is the function that the current passing through the LED affected by the environment temperature.

The DC input voltage V_{DC} of LEDs 12 is provided by an AC/DC converter (adapter) 14. The AC/DC converter 14 is used to transform an AC voltage V_{ac}, for example, an AC voltage of city electrical power to a DC electrical power source which has a DC voltage V_{DC}.

In this embodiment, the constant power driving-and-controlling method 100 for lighting elements includes a power measuring device (sensor) 16, the power measuring device 16 is connected to LEDs 12 respectively to measure the input power P of each LED 12. In this embodiment, a current measuring device 160 is (serially) connected to the input ends of LEDs 12 for measuring the current I of LEDs 12; a voltage measuring device 162 is (parallel) connected to the input ends of LEDs 12 for measuring the DC voltage V_{DC}. The current I measured by the current measuring device 160 and the DC voltage V_{DC} measured by the voltage measuring device 162 are both input to the multiplier 164 for multiplying the current by the input voltage so as to get the input power P of LEDs. The multiplier 164 of this embodiment is based on the theory P=V×I.

The power P measured by the power measuring device 16 is fed back returned to a controller 18, a output signal of the controller 18 is used to control the AC/DC converter 14. For example, when the environment temperature changes; the input power P changes. The feedback controller 18 changes the output signal according to a pre-set power value Pₛₑₜ so as to change the DC voltage V_{DC} and the current passing through the LEDs, and stabilize the input power of the LED 12 by controlling a adjustable element (variable resistance) of the AC/DC converter 14. Whereby, the constant power driving-and-controlling apparatus 100 is able to make the output illumination of the LED stabilized in different environment temperatures.

Further included in this embodiment is a substrater 180 for obtaining a difference value between the pre-set reference power value Pₛₑₜ and the power P measured by the power measuring device 16. The difference value is inputted to a controller 182 for controlling the output DC voltage V_{DC} of the AC/DC converter 14 according to the difference value, until the power P of LEDs 12 equals the pre-set reference power value Pₛₑₜ. For example, when the difference value is negative, the AC/DC converter 14 would undergo controlling to decrease the DC voltage V_{DC}; on the contrary, when the difference value is positive, the AC/DC converter 14 would be controlled to increase the DC voltage V_{DC}. The controller 182 can be a circuit or a controller controlled by software such as a microprocessor. In other embodiments, the power P measured by the power measuring device 16 is directly input to the controller without the substrater 180. According to the power P, a corresponding output for the AC/DC converter 14 is directly produced, for example, by a table. Although the pre-set reference power value Pₛₑₜ mentioned-above is a fix value, it is also possible to dynamically adjust the pre-set reference power value Pₛₑₜ by a controller or other elements according to different applications so as to adjust the input power of the LEDs for adjusting the output illumination.

FIG. 1B shows an electrical connect flow diagram of a constant power driving-and-controlling method 102 for lighting elements in accordance with another preferred embodiment of the present invention. The elements of this embodiment are the same as the embodiment shown in FIG. 1A, and figures of the elements are also the same as the embodiment shown in FIG. 1A, for example, the description about the LEDs 12 and the power measuring device 16, therefore it is not mentioned again in this paragraph. The difference between this embodiment and the embodiment shown in FIG. 1A lies in the output electrical power source of the AC/DC converter 14. In FIG. 1A, the AC/DC converter 14 is voltage output, and the controller feedbacks the power of the LEDs 12 and controls the output voltage V_{DC} of the AC/DC converter 14 so as to achieve the purpose of the constant power control. The output electrical power source of the AC/DC converter 14 shown in FIG. 1B is current output, and the controller feedbacks the power of the LEDs 12 and controls the output current I_{DC} of the AC/DC converter 14 so as to achieve the purpose of the constant power control.

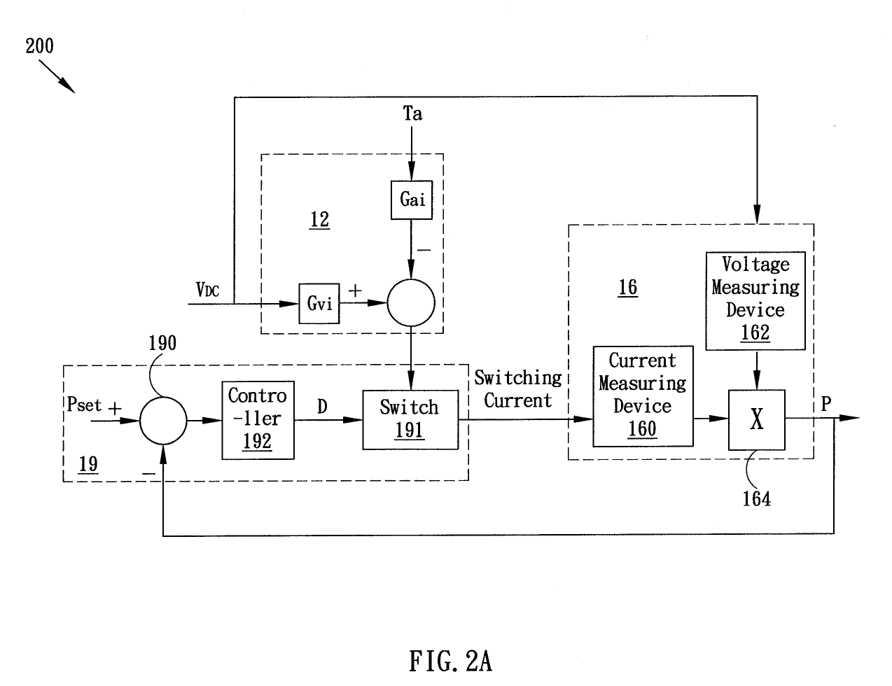

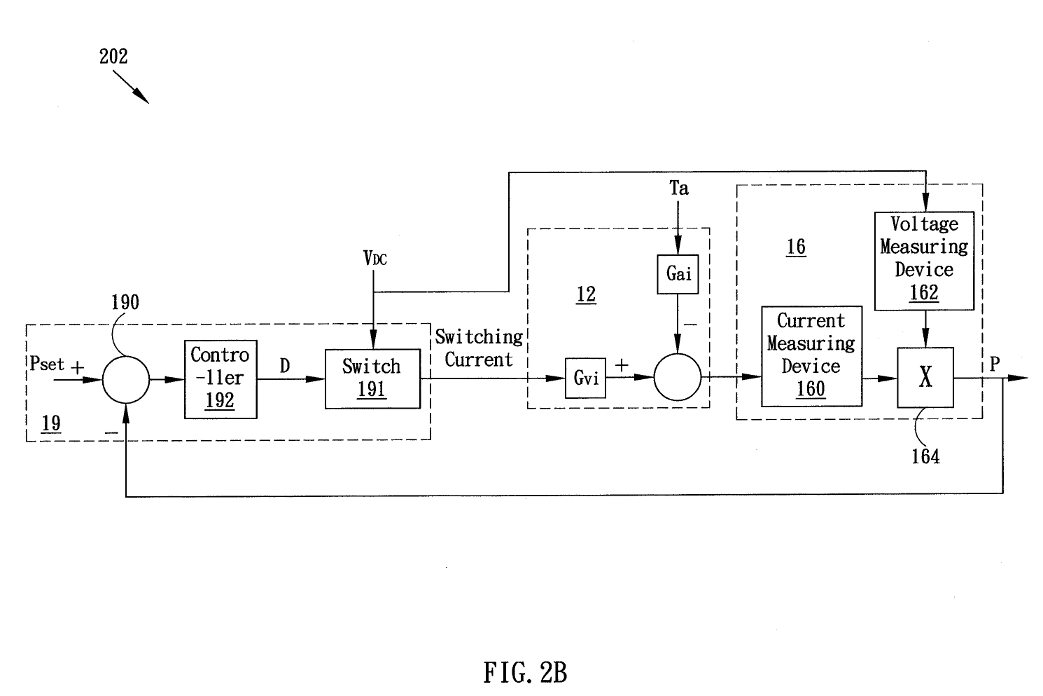

FIG. 2A shows an electrical connect flow diagram of a constant power driving-and-controlling method 200 for lighting elements in accordance with another preferred embodiment of the present invention. The elements of this embodiment are the same as the embodiment shown in FIG. 1A, and figures of the elements are also the same as the embodiment shown in FIG. 1A, for example, the description about the LEDs 12 and the power measuring device 16, and therefore it is not mentioned again in this paragraph. In this embodiment, the DC voltage V_{DC} is a directly input without an AC/DC converter. However, in other embodiments, an AC/DC converter can be used to acquire a DC voltage V_{DC}. The DC voltage V_{DC} of this embodiment can be floating or fixed, for example, a power source provided by a solar cell or a battery is floating; a power source provided by an AC/DC converter or a DC/DC converter is fixed. Moreover, it is also possible to input a DC current to the LEDs so as to replace the input source of the DC voltage V_{DC}. This embodiment is different from the embodiment shown in FIG. 1A. The LEDs shown in FIG. 1A are driven by a continuous current; the LEDs of this embodiment are driven by a switching current. In this embodiment, the output ends of the LEDs 12 are serially connected to a switch device 191 of the feedback controller 19. Because switch device 191 turns on and off discontinuously, the LEDs 12 light up discontinuously. By controlling a duty cycle of the switch device 191, the lighting time ratio of the LEDs 12 is controlled, thus the input power P of the LEDs 12 can be controlled. Because the switching frequency is higher than the sensibility of the human eyes, the off-time is not perceptible to the human eyes. The switch device 191 can be a MOSFET (Metal-Oxide-Semiconductor Field-Effect Transistor), a PWM (Pulse Width Modulation) element, or any other element capable of being used as a switch.

In this embodiment, the current measuring device 160 and the voltage measuring device 162 include a signal processor respectively. The signal processors transform the switching of the DC current I measured and the DC voltage V_{DC} measured to continuous average signals respectively. Then the continuous average signals are both input to the multiplier 164 for multiplying the average current by the average voltage so as to get the average input power P. The average power P measured by the power measuring device 16 is fed back to a feedback controller 19 respectively.

The feedback controller 19 includes a substrater 190 for accquiring a difference value between the pre-set reference power value Pₛₑₜ and the power P measured by the power measuring device 16. The difference value is inputted to a controller 192, then a duty cycle controlling signal D is produced according to the difference value to control the switch device 191 and the lighting of the LEDs 12. Whereby, the input power of the LEDs is stabilized, and the output illumination becomes stable because of the constant power driving-and-controlling method 200 for lighting elements.

Similar to the foregoing embodiments, the controller 192 can be a circuit or a controller which is controlled by software such as a microprocessor. The power P measured by the power measuring device 16 can be directly inputted to the controller without the substrater 190. According to the power P, a corresponding duty cycle controlling signal for the switch device 191 is directly produced, for example, by a table.

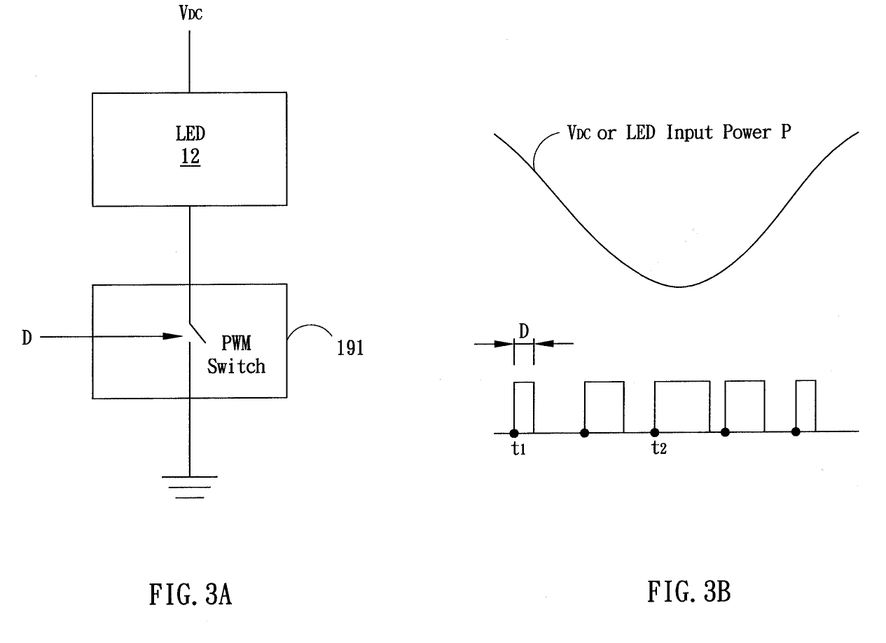

FIG. 3A shows a part of the constant power driving-and-controlling method 200 for lighting elements shown in FIG. 2A. Of note, a PWM switch (Pulse Width Modulation switch) is used as a switch device 191. One end of the PWM switch 191 is connected to the output ends of the LEDs 12, another end of the PWM switch 191 is connected to the ground. FIG. 3B shows the relation between the DC voltage V_{DC} (or power P) shown in FIG. 3A and the duty cycle controlling signal D. Referring to FIG. 3B, the DC voltage V_{DC} is floating. When the DC voltage V_{DC} (or power P) is too high, for example, in time t₁, the pulse width of the duty cycle controlling signal D becomes narrower so as to shorten the lighting time ratio of the LEDs 12; when the DC voltage V_{DC} (or power P) is too low, for example, in time t₂, the pulse width of the duty cycle controlling signal D becomes wider so as to extend the lighting time ratio of the LEDs 12. Whereby, even when the DC voltage V_{DC} or the current I_{DC} is floating, the input power is allowed to remain constant. Moreover, when the environment temperature decreases/increases, the resistance of the P-N junction of the LEDs 12 increases/decreases, the feedback controller 19 is able to control the PWM switch 191 by the same theory so as to stabilize the input power of the LEDs. Whereby protect the LEDs 12 from burning out because the weather is too hot (the environment temperature increases); prevent the output illumination of the LEDs 12 from being too low because the weather is too cold (the environment temperature decreases).

FIG. 2B shows an electrical connect flow diagram of a constant power driving-and-controlling method 202 for lighting elements in accordance with another preferred embodiment of the present invention. The elements of this embodiment are the same as the embodiment shown in FIG. 2A except that the controlling method is a little different. Also, the connecting relation of this embodiment is similar to the embodiment shown in FIG. 1A.

What is different from the embodiment shown in FIG. 2A is the switching device 191, for example, the PWM switch. The switching device is serially connected between the LEDs 12 and the DC voltage V_{DC}. The LEDs 12 is connected to the power measuring device 16. With the connecting relation, the feedback controller 19 controls the DC voltage V_{DC} according to the pre-set reference power value Pₛₑₜ and the power P measured by the power measuring device 16, determining which one of the duty cycles to provide DC voltage V_{DC} to the LEDs 12.

Using the embodiments of the present invention described above, it is possible to reduce the impact of the environment temperature on the input power of the lighting elements, reduce the effects of the unstable input voltage and current on the input power of the lighting elements, and eliminate the disturbance of application such as excessive or insufficient illumination of the lighting elements, or damages to the lighting elements due to changing electrical characteristics of the lighting elements from different production lots, which might have effects on the input power of the lighting elements. Whereby protect the lighting elements and extend the lifetime of the lighting elements, moreover, stabilize the output illumination of the lighting elements.

Although specific embodiments have been illustrated and described, it will be appreciated by those skilled in the art that various modifications may be made without departing from the scope of the present invention, which is intended to be limited solely by the appended claims.

What is claimed is:

1. A constant power driving-and-controlling method for lighting elements, comprising:
at least one lighting element;
a power measuring device for measuring an input power of said lighting element; and
a feedback controller for receiving a power signal of said power measuring device and outputting a control signal according to said power signal.

2. The constant power driving-and-controlling method for lighting elements according to claim 1, wherein said lighting element comprises LED.

3. The constant power driving-and-controlling method for lighting elements according to claim 1, wherein said power measuring device comprises:
a current measuring device for measuring a current passing through said lighting element;
a voltage measuring device for measuring an input voltage of said lighting element; and
a multiplier for multiplying said current by said input voltage so as to get said input power.

4. The constant power driving-and-controlling method for lighting elements according to claim 1, further comprising a power supply for providing DC current to said lighting element, wherein said power supply is capable of receiving said control signal outputted from said feedback controller and changing an output of said power supply according to said control signal so as to stabilize said input power of said lighting element.

5. The constant power driving-and-controlling method for lighting elements according to claim 4, wherein said feedback controller comprises:
a substrater for getting a difference value between a pre-set reference power and said input power; and
a controller for controlling said output of said power supply according to the difference value.

6. The constant power driving-and-controlling method for lighting elements according to claim 1, further comprising a power supply for providing a DC current to said lighting element.

7. The constant power driving-and-controlling method for lighting elements according to claim 6, wherein said feedback controller comprises:
a substrater for getting a difference value between a pre-set reference power and said input power;
a controller for getting a duty cycle controlling signal according to said difference value; and
a switch device serially connected an output end of said lighting element and being controlled by said duty cycle controlling signal for controlling said input power of said lighting element.

8. The constant power driving-and-controlling method for lighting elements according to claim 6, wherein said feedback controller comprises:
a substrater for getting a difference value between a pre-set reference power and said input power;
a controller for getting a duty cycle controlling signal according to said difference value; and
a switch device serially connected between said lighting element and said power supply, said switch device being controlled by said duty cycle controlling signal for controlling said input power of said lighting element.

9. A constant power driving-and-controlling apparatus for LEDs, comprising:
at least one LED;
a power supply for providing a DC current to an input end of said LED;
a power measuring device for measuring the input power of said LED; and
a feedback controller for controlling an output of said power supply according to a pre-set input power value, whereby controlling said input power of said LED.

10. The constant power driving-and-controlling apparatus for LEDs according to claim 9, wherein said power measuring device comprises:
a current measuring device for measuring a current passing through said LED;
a voltage measuring device for measuring an input voltage of said LED; and
a multiplier for multiplying said current by said input voltage so as to get said input power of said LED.

11. The constant power driving-and-controlling apparatus for LEDs according to claim 9, wherein said feedback controller comprises:
a substrater for getting a difference value between a pre-set reference power and said input power; and
a controller for controlling said output of said power supply according to said difference value.

12. The constant power driving-and-controlling apparatus for LEDs according to claim 11, wherein said pre-set reference power has a plurality of values, said pre-set reference power is capable of dynamically adjusting so as to make said LED be able to adjust dynamically input power in special applying conditions.

13. A constant power driving-and-controlling apparatus for LEDs, comprising:
at least one LED;
a DC current source for providing a DC current to an input end of said LED;
a power measuring device for measuring an input power of said LED; and
a feedback controller connected to an output end of said LED respectively, said feedback controller controlling the said DC current of said LED according to a pre-set input power value.

14. The constant power driving-and-controlling apparatus for LEDs according to claim 13, wherein said power measuring device comprises:
a current measuring device for measuring an output current of said LED;
a voltage measuring device for measuring the input voltage of said LED; and
a multiplier for multiplying the current by an input voltage so as to get said input power.

15. The constant power driving-and-controlling apparatus for LEDs according to claim 13, wherein said feedback controller comprises:
a substrater for getting a difference value between a pre-set reference power and said input power;
a controller for getting a duty cycle controlling signal according to said difference value; and
a switch device serially connected to said output end of said LED, said switch device being controlled by said duty cycle controlling signal for controlling a duty cycle of said LED.

16. The constant power driving-and-controlling apparatus for LEDs according to claim 15, wherein said pre-set reference power has a plurality of values, said pre-set reference power is capable of dynamically adjusting so as to make said LED be able to adjust said input power in special applying conditions.

17. The constant power driving-and-controlling apparatus for LEDs according to claim 15, wherein said switch device comprises a PWM switch, one end of said PWM switch connected to said LED, another end of said PWM switch connected to the ground.

18. A constant power driving-and-controlling apparatus for LEDs, comprising:
at least one LED;
a DC current source for providing a DC current to said LED;
a power measuring device for measuring an input power of said LED respectively; and
a feedback controller connected to said DC current source and an output end of said LED respectively, said feedback controller controlling said DC current of said LED according to said input power.

19. The constant power driving-and-controlling apparatus for LEDs according to claim 18, wherein said power measuring device comprises:
a current measuring device for measuring a current passing through said LED;
a voltage measuring device for measuring an input voltage of said LED; and
a multiplier for multiplying said current by said input voltage so as to get said input power.

20. The constant power driving-and-controlling apparatus for LEDs according to claim 18, wherein said feedback controller comprises:
a substrater for getting a difference value between a pre-set reference power and said input power;
a controller for getting a duty cycle controlling signal according to said difference value; and
a switch device serially connected between said DC current source and said output end of said LED, said switch device being controlled by said duty cycle controlling signal for controlling said DC current source to provide said DC current to said LED according to which one of duty cycles.

21. The constant power driving-and-controlling apparatus for LEDs according to claim 20, wherein said switch device comprises a PWM switch, one end of said PWM switch connected to said DC current source, another end of said PWM switch connected to said LED.
